(19) United States
(12) Patent Application Publication
(10) Pub. No.: US 2016/0008210 A1
(43) Pub. Date: Jan. 14, 2016

(54) Massage Head Unit with Axle and Asymmetric Cantilever

(71) Applicant: ST LIFE CO., LTD., Taichung City (TW)

(72) Inventor: Jue-Yao Chen, Taichung City (TW)

(21) Appl. No.: 14/327,599

(22) Filed: Jul. 10, 2014

(51) Int. Cl. A61H 15/00

(52) U.S. Cl. CPC A61H 15/00; A61H 15/0078; A61H 2015/0042

(57) ABSTRACT

A massage head unit with axle and asymmetric cantilever includes: a depressed receiving space; two cantilevers flanking the depressed receiving space asymmetrically, extending upward, and each having a top surface on which at least a massage bump is disposed; and a turntable disposed on an axle disposed centrally at the depressed receiving space and having a top surface on which at least a massage hemisphere is disposed, wherein the cantilevers swing asymmetrically to perform a kneading massage, whereas the turntable performs a rotating pressing massage.

### BACKGROUND OF THE INVENTION

1. Technical Field

The present invention relates to the technical field of massage head units, and more particularly, to a massage head unit with axle and asymmetric cantilever which comprises a depressed receiving space, two cantilevers flanking the depressed receiving space asymmetrically, extending upward, and each having at least a massage bump, and a turntable disposed on an axle disposed centrally at the depressed receiving space and having at least a massage hemisphere, such that the massage head unit performs a rotating massage centrally and performs a kneading massage at two diametric positions.

2. Description of Related Art

People nowadays work much but spend little time on leisure activities. Being tense all the time, people nowadays crave a break from one's toils. In view of this, it is necessary for people nowadays to go for a massage. A massage does not take up much space, nor does it require participants to move around; hence, persons at rest can have a massage to exercise and relax the body, thereby getting good rest. When carried out properly, muscle exercise enhances blood circulation, boosts metabolism, keeps the body healthy, and reduces stress.

Conventional massagers perform a massage monotonously. For example, Taiwan patent application 099215160 is entitled Turning-style Massager Structure, regarded as one of the commonest types of massagers, that is, disc massagers, and adapted to perform a rotating massage. Although the disc massagers can also move vertically and laterally, the disc massagers are intended mostly for the rotating massage and in consequence are impossible to exercise and relax every muscle of the body. As a result, there is still room for improvement of conventional massagers.

### SUMMARY OF THE INVENTION

It is an objective of the present invention to provide a massage head unit with axle and asymmetric cantilever which comprises a depressed receiving space, two cantilevers flanking the depressed receiving space asymmetrically, extending upward, and each having at least a massage bump, and a turntable disposed on an axle disposed centrally at the depressed receiving space and having at least a massage hemisphere, such that the massage head unit performs a rotating massage centrally and performs a kneading massage at two diametric positions.

In order to achieve the above and other objectives, the present invention provides a massage head unit with axle and asymmetric cantilever, comprising: a depressed receiving space; two cantilevers flanking the depressed receiving space asymmetrically, extending upward, and each having a top surface on which at least a massage bump is disposed; and a turntable disposed on an axle disposed centrally at the depressed receiving space and having a top surface on which at least a massage hemisphere is disposed, wherein the cantilevers swing asymmetrically to perform a kneading massage, whereas the turntable performs a rotating pressing massage.

### BRIEF DESCRIPTION OF THE DRAWINGS

Objectives, features, and advantages of the present invention are hereunder illustrated with specific embodiments in conjunction with the accompanying drawings, in which:

FIG. 1 is an exploded view of a massage head unit taken from an angle according to an embodiment of the present invention;

FIG. 2 is an exploded view of the massage head unit taken from another angle according to an embodiment of the present invention;

FIG. 3 is an exploded view of the massage head unit taken from yet another angle according to an embodiment of the present invention;

FIG. 4 is a schematic perspective view of the massage head unit according to an embodiment of the present invention;

FIG. 5 is a schematic top view of the massage head unit integrated into a massager according to an embodiment of the present invention;

FIG. 6 is a schematic perspective view of the massage head unit integrated into a massager according to the present invention;

FIG. 7 is a schematic perspective view of the massage head unit integrated into a massager disposed in a massage pillow according to the present invention;

FIG. 8 is a schematic perspective view of the massage head unit integrated into a massager disposed in a massage chair pad according to the present invention; and

FIG. 9 is a schematic perspective view of the massage head unit integrated into a massager disposed in a massage chair according to the present invention.

### DETAILED DESCRIPTION OF THE EMBODIMENT OF THE INVENTION

The present invention provides a massage head unit with axle and asymmetric cantilever.

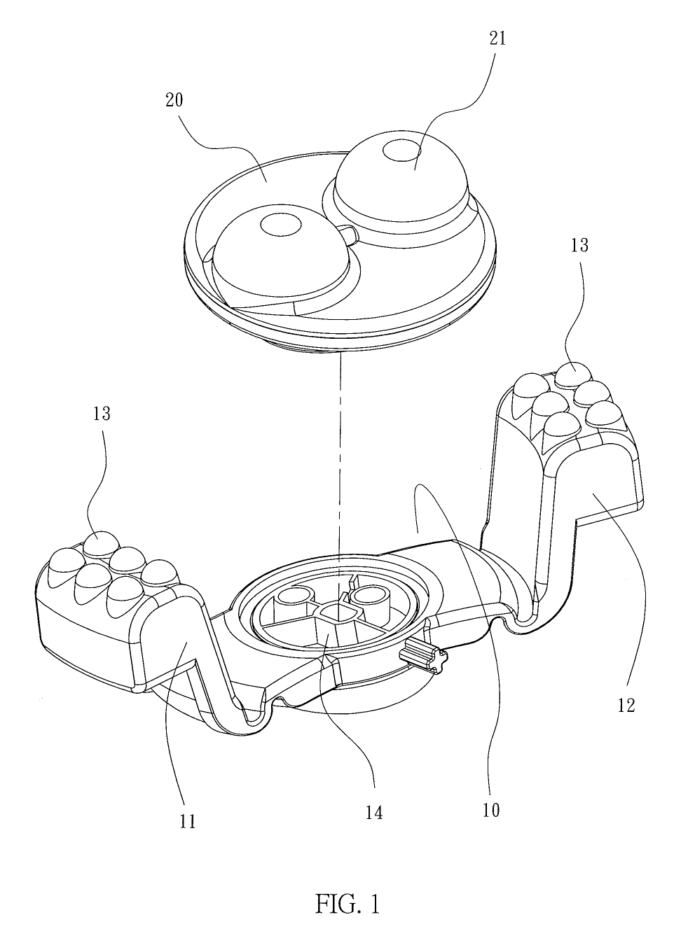

Referring to FIG. 1, according to the present invention, a massage head unit with axle and asymmetric cantilever comprises a depressed receiving space 10, two cantilevers 11, 12, and a turntable 20.

The cantilevers 11, 12 flank the depressed receiving space 10 asymmetrically and extend upward. The cantilevers 11, 12 each have a top surface on which at least a massage bump 13 is disposed. The turntable 20 is disposed on an axle 14 disposed centrally at the depressed receiving space 10. The turntable 20 has a top surface on which at least a massage hemisphere 21 is disposed. The cantilevers 11, 12 swing asymmetrically to drive the massage bumps 13 to swing and thus perform a kneading massage, whereas the turntable 20 rotates to drive the massage hemisphere 21 to perform a rotating pressing massage.

Regarding the massage head unit with axle and asymmetric cantilever, the massage hemisphere 21 is provided in the form of two massage hemispheres 21.

Regarding the massage head unit with axle and asymmetric cantilever, the two massage hemispheres 21 are provided in the form of a large massage hemisphere 21 and a small massage hemisphere 21.

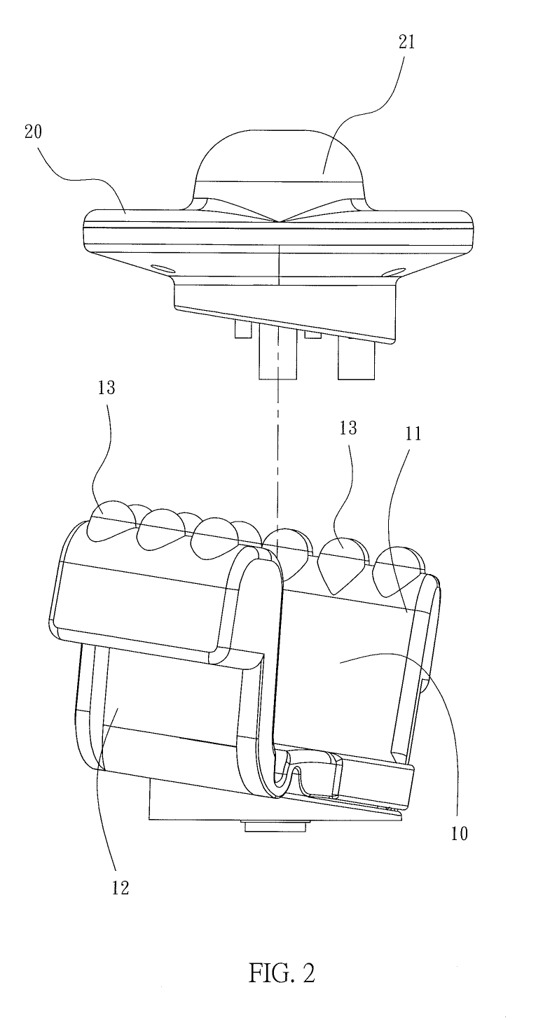

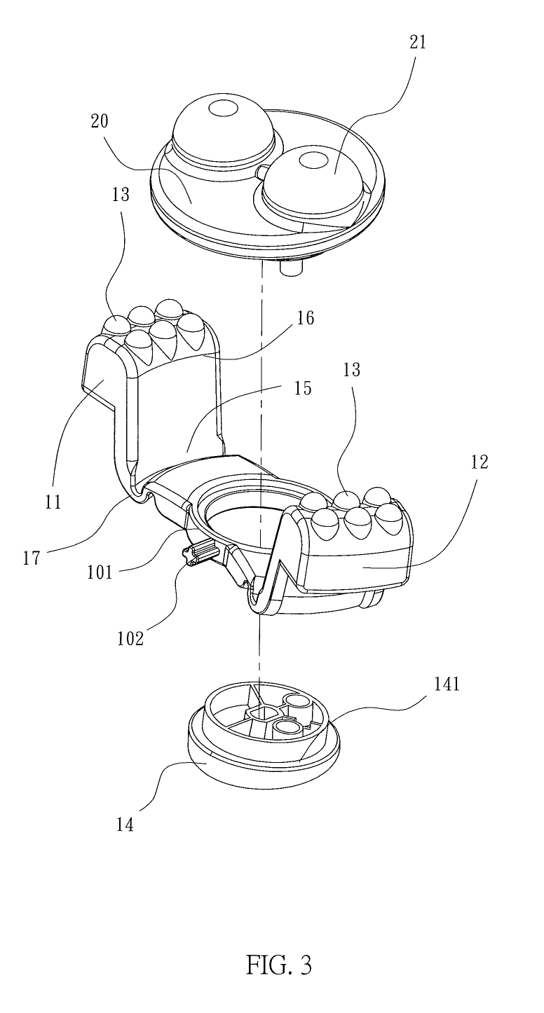

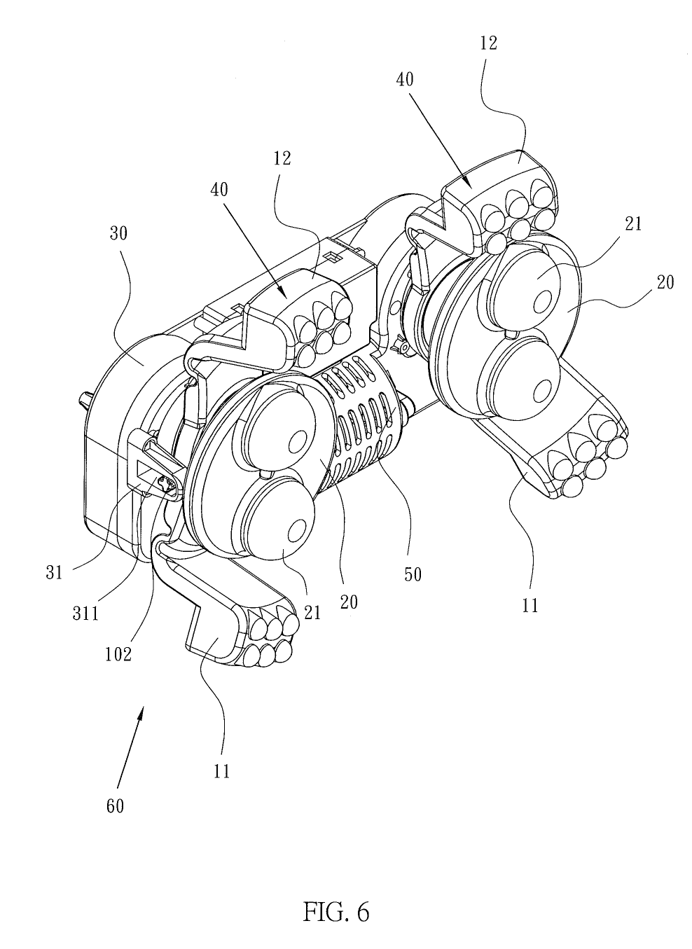

Referring to FIGS. 2, 3, regarding the massage head unit with axle and asymmetric cantilever, a ring 101 is disposed centrally at the depressed receiving space 10. The axle 14 has an oblique stepped surface 141. The oblique stepped surface 141 is engaged with the ring 101. The ring 101 is peripherally coupled to a cruciform protruding rod 102. Referring to FIG. 6, a casing 30 is provided, and the casing 30 comprises a slot element 31 which protrudes from the casing 30. A slot 311 is disposed centrally at the slot element 31. The slot 311 is penetrable by the cruciform protruding rod 102, such that the slot 311 limits the range of motion of the cruciform protruding rod 102. The cruciform protruding rod 102, the ring 101, and the cantilevers 11, 12 are integrally formed. As the axle 14 rotates, the oblique stepped surface 141 drives the cantilevers 11, 12 to swing while being limited by the slot 311.

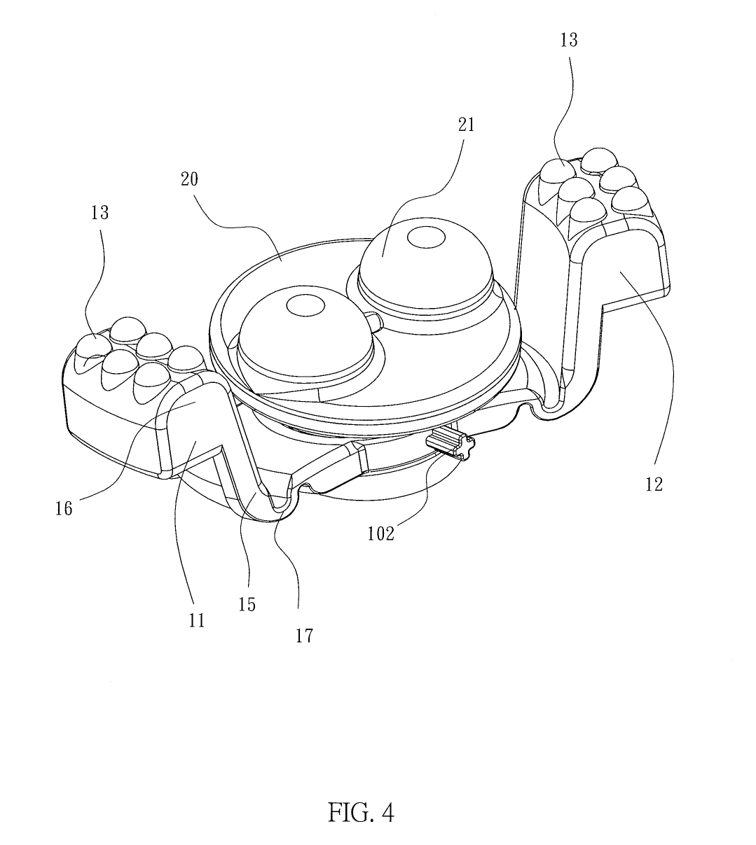

Referring to FIG. 1 through FIG. 4, regarding the massage head unit with axle and asymmetric cantilever, the cantilevers 11, 12 each comprise a driven side 15 and an active side 16. A U-shaped resilient structure 17 is integrally formed to connect the depressed receiving space 10 and the driven side 15 of the cantilever 11. Another U-shaped resilient structure 17 is integrally formed to connect the depressed receiving space 10 and the driven side 15 of the cantilever 12. Due to the U-shaped resilient structures 17, the massage bumps 13 at the active sides 16 of the cantilevers 11, 12 can undergo resilient displacement and resilient restoration when subjected to an external force, thereby enhancing the flexibility of the cantilevers 11, 12 and the comfort of massage.

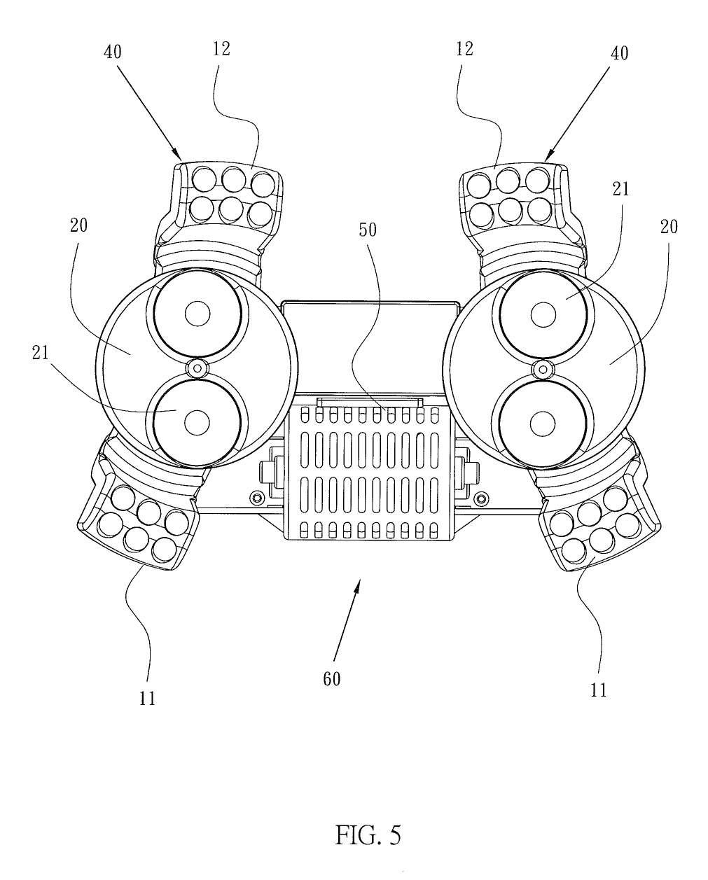

Referring to FIG. 5 and FIG. 6, regarding the massage head unit with axle and asymmetric cantilever, two massage head units 40 with axle and asymmetric cantilever are arranged side by side, having a same shape and mirror-image symmetry. A casing 50 is connected between the two massage head units 40 with axle and asymmetric cantilever. The casing 50 has therein a power mechanism (not shown). The power mechanism drives the two massage head units 40 with axle and asymmetric cantilever and enables each said massage head unit 40 with axle and asymmetric cantilever to perform a stationary massage and the cantilevers 11, 12 to perform a swinging massage. The two massage head units 40 with axle and asymmetric cantilever, the casing 50, and the power mechanism together form a massager 60. The massager 60 performs stationary, swinging, and kneading massage across an area of the shoulders, neck, and back of a human body according to the width of the cantilevers 11, 12 positioned asymmetrically.

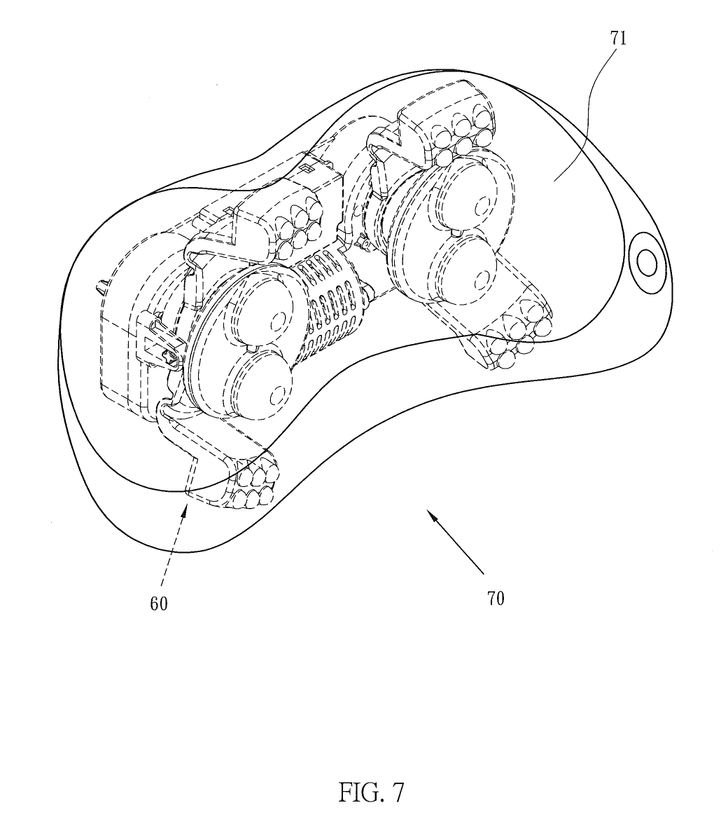

Referring to FIG. 7, regarding the massage head unit with axle and asymmetric cantilever, the massager 60 is disposed in a massage pillow 71, so as to form a massage pillow-style massager 70.

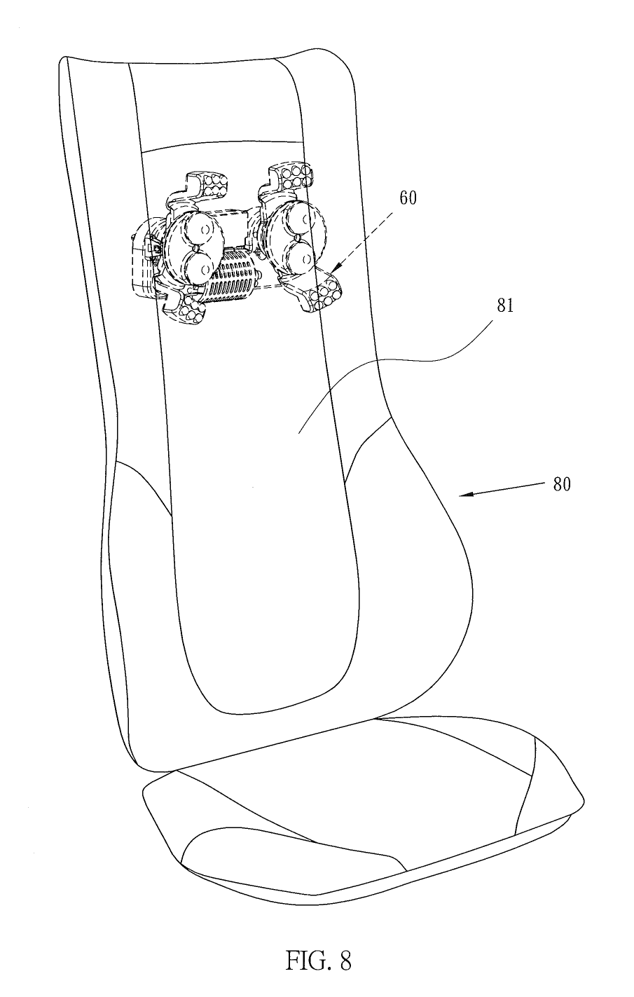

Referring to FIG. 8, regarding the massage head unit with axle and asymmetric cantilever, the massager 60 is disposed in a massage chair pad 81, so as to form a massage chair pad-style massager 80.

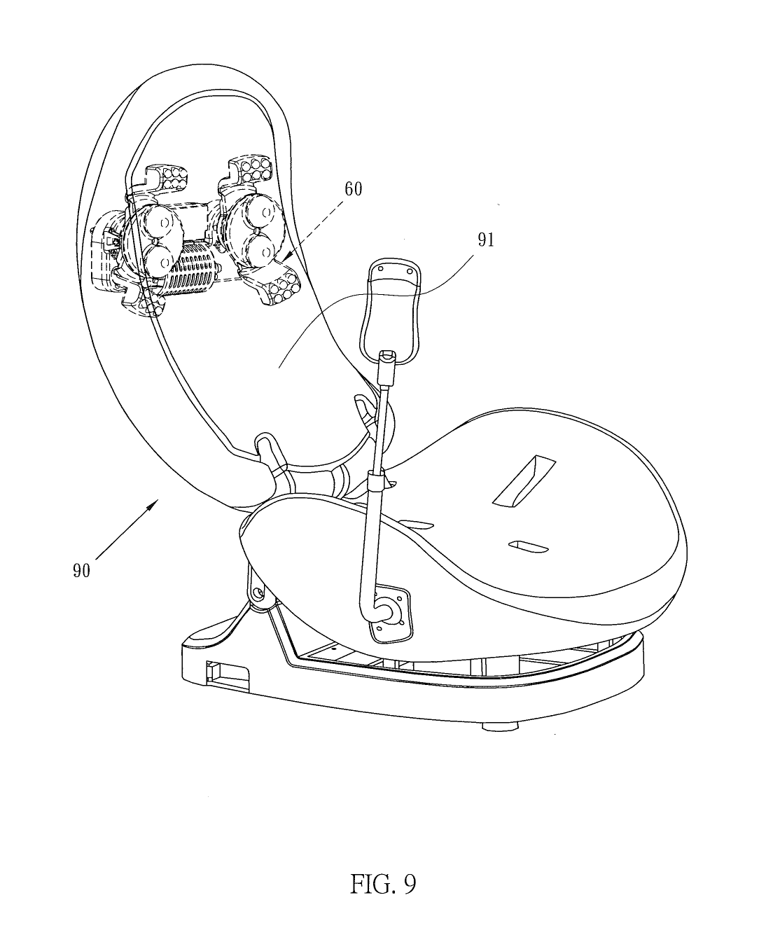

Referring to FIG. 9, regarding the massage head unit with axle and asymmetric cantilever, the massager 60 is disposed in a massage chair 91, so as to form a massage chair-style massager 90.

According to the present invention, a massage head unit with axle and asymmetric cantilever is novel and thus meets the novelty requirements of a patent. It is extensively innovative and thus meets the non-obviousness requirement of a patent. The massage head unit with axle and asymmetric cantilever comprises a depressed receiving space, two cantilevers flanking the depressed receiving space asymmetrically, extending upward, and each having at least a massage bump, and a turntable disposed on an axle disposed centrally at the depressed receiving space and having at least a massage hemisphere, such that the massage head unit performs a rotating massage centrally and performs a kneading massage at two diametric positions. Therefore, the massage head unit with axle and asymmetric cantilever has high industrial applicability.

What is claimed is:

1. A massage head unit with axle and asymmetric cantilever, comprising:
a depressed receiving space;
two cantilevers flanking the depressed receiving space asymmetrically, extending upward, and each having a top surface on which at least a massage bump is disposed; and
a turntable disposed on an axle disposed centrally at the depressed receiving space and having a top surface on which at least a massage hemisphere is disposed,
wherein the cantilevers swing asymmetrically to drive the massage bumps to swing and thus perform a kneading massage, whereas the turntable rotates to drive the massage hemisphere to perform a rotating pressing massage.

2. The massage head unit with axle and asymmetric cantilever of claim 1, wherein the massage hemisphere is provided in form of two massage hemispheres.

3. The massage head unit with axle and asymmetric cantilever of claim 2, wherein the two massage hemispheres are provided in form of a large massage hemisphere and a small massage hemisphere.

4. The massage head unit with axle and asymmetric cantilever of claim 1, wherein a ring is disposed centrally at the depressed receiving space, the axle has an oblique stepped surface engageable with the ring, the ring is peripherally coupled to a cruciform protruding rod, a casing includes a slot element protruding from the casing, a slot is disposed centrally at the slot element and penetrable by the cruciform protruding rod, such that the slot limits a range of motion of the cruciform protruding rod, wherein the cruciform protruding rod, the ring, and the cantilevers are integrally formed, such that as the axle rotates, the oblique stepped surface drives the cantilevers to swing while being limited by the slot.

5. The massage head unit with axle and asymmetric cantilever of claim 1, wherein the cantilevers each comprise a driven side and an active side, and a U-shaped resilient structure is integrally formed to connect the depressed receiving space and the driven side of each of the cantilevers such that, due to the U-shaped resilient structures, the massage bumps at the active sides of the cantilevers undergo resilient displacement and resilient restoration when subjected to an external force, thereby enhancing flexibility of the cantilevers and comfort of massage.

6. The massage head unit with axle and asymmetric cantilever of claim 1, wherein the massage head unit is provided in form of two massage head units arranged side by side, having a same shape and mirror-image symmetry, and a casing is connected between the two massage head units, the casing having therein a power mechanism for driving the two massage head units to perform a stationary massage and the cantilevers to perform a swinging massage, wherein the two massage head units, the casing, and the power mechanism together form a massager for performing stationary, swinging, and kneading massage across an area of shoulders, neck, and back of a human body according to a width of the cantilevers positioned asymmetrically.

7. The massage head unit with axle and asymmetric cantilever of claim 6, wherein the massager is disposed in a massage pillow, so as to form a massage pillow-style massager.

8. The massage head unit with axle and asymmetric cantilever of claim 6, wherein the massager is disposed in a massage chair pad, so as to form a massage chair pad-style massager.

9. The massage head unit with axle and asymmetric cantilever of claim 6, wherein the massager is disposed in a massage chair, so as to form a massage chair-style massager.
